(19) United States
(12) Patent Application Publication
(10) Pub. No.: US 2008/0175773 A1
(43) Pub. Date: Jul. 24, 2008

(54) Process for the dissolution of copper metal

(76) Inventors: H. Wayne Richardson, Sumter, SC (US); Gang Zhao, Sumter, SC (US)

Correspondence Address: HAYDEN STONE, PLLC, 101 NORTH COLUMBUS ST., SUITE 409, ALEXANDRIA, VA, 22301, US

(21) Appl. No.: 11/980,524

(22) Filed: Oct. 31, 2007

Related U.S. Application Data
(63) Continuation-in-part of application No. 11/046,804, filed on Feb. 1, 2005.
Application No. 11/046,804 is a continuation-in-part of application No. 10/660,795, filed on Sep. 12, 2003, now Pat. No. 6,905,531.
Application No. 10/660,795 is a continuation of application No. 10/074,251, filed on Feb. 14, 2002, now Pat. No. 6,646,147.
(60) Provisional application No. 60/608,538, filed on Sep. 10, 2004.

(51) Int. Cl. B01F 1/00

(52) U.S. Cl. 423/27

(57) ABSTRACT

A method of dissolving a copper mass includes contacting a copper mass with an oxidant such as air and an aqueous leach liquor containing monoethanolamine (“MEA”) and (HMEA)₂CO₃, wherein said leach liquor is produced by partially carbonating the MEA, and said leach liquor further contains between 1.9 g/L and 13.7 g/L of dissolved copper, forms a liquid product comprising between 100 and 130 g Cu/L in 48 hours or less.

### RELATED APPLICATIONS

The present application is a continuation-in-part of pending U.S. application Ser. No. 11/046,804 filed on Feb. 1, 2005, which in turn claims priority to Provisional No. 60/608,538 filed Sep. 10, 2004, and also claims priority as a continuation-in-part of U.S. application Ser. No. 10/660,795 filed Sep. 12, 2003, now U.S. Pat. No. 6,905,531, which is a continuation of U.S. application Ser. No. 10/074,251 filed Feb. 14, 2002, now U.S. Pat. No. 6,646,147, the contents of which are incorporated herein by reference thereto.

### STATEMENT REGARDING FEDERALLY SPONSORED RESEARCH OR DEVELOPMENT

NOT APPLICABLE.

### INCORPORATION-BY-REFERENCE OF MATERIAL SUBMITTED ON A COMPACT DISC

NOT APPLICABLE.

### FIELD OF THE INVENTION

The present invention relates to a process for the rapid dissolution of copper metal in an aqueous alkanolamine composition. More particularly, the invention relates to a process for producing a copper-containing aqueous solution by dissolving copper in an aqueous leach liquor containing both monoethanolamine (“MEA”) and monoethanolammonium-copper-salts and in the presence of an oxidant, at copper dissolution rates in excess of 2.1 grams of copper per liter per hour, where at least a portion of the (monoethanolammonium) salts are carbonates.

### BACKGROUND ART

It is known to employ copper-containing aqueous solutions as biocide fluids, for example, for the pressure treatment of lumber and for water purification. Copper-containing solutions may be produced by reacting copper oxide with chromic acid and arsenic acid to produce a solution of the copper with chrome and arsenic. The solution is subsequently diluted with water and the resulting aqueous solution may be injected into wood under pressure. This chromated copper arsenate (“CCA”) is the primary additive used in the treatment of wood against termite and other biological infestation. Although the CCA is very effective, it has come under increased pressure because of the environmental concerns associated with chromium and arsenic.

A new generation of pesticide is now emerging that appears to be efficacious, and which relies on the use of copper (in larger quantities than in the CCA) in combination with other pesticidal components, such as quaternary amines and triazoles. The copper is typically applied as a solution of the monoethanolamine complex of copper carbonate or borate. The commercial form of the copper concentrate usually contains about 100 to 130 g/l copper which is diluted with water prior to injection into the wood.

It is known to dissolve copper salts, including particularly copper carbonate, in MEA. The copper carbonate precursor is expensive, relative to scrap copper metal, and a brine waste is generated by the above process which gives rise to environmental concerns.

It is known from the prior art that ammonia and carbon dioxide added to water can be used to dissolve copper metal with oxygen from air as the oxidant. This is represented by the following equation: Cu+2NH₃+(NH₄)₂CO₃+½O₂=>Cu(NH₃)₄CO₃+H₂O. The reaction proceeds well and has been the basis for copper dissolution in several commercial facilities.

Other examples of dissolution of copper or copper salts utilizing such fluids and uses thereof may be found, for example, in U.S. Pat. No. 4,929,454 and U.S. Pat. No. 6,294,071. The copper-containing solutions may be formulated, for example, by dissolving copper in aqueous solutions containing alkyl amines or alkyl hydroxy amines, such as 2-hydroxyethylamine. U.S. Pat. No. 6,294,071 states “in one conventional batch process for producing copper-containing amine solutions, approximately five days is required to achieve the target copper concentration (i.e., about 8%),” and subsequently discloses a method to dissolve copper that requires the imposition of a galvanic or electrolytic driving force to accelerate the process to provide a product after dissolution “of about one day”. The use of electricity is not desirable, as the energy costs can be significant, and the process (having large electric current flows through flammable and/or explosive solvents) is inherently hazardous.

U.S. Pat. No. 5,078,912 discloses a composition that contains copper, MEA, free alkali, and a salt of a fungicidal anion (such as fluoride, borate, or fluoroborate). The process of manufacture of this composition comprises dissolving copper salts, e.g., copper carbonate. U.S. Pat. No. 4,808,407 discloses a process to prepare water soluble copper salts of carboxylic acids, said acid containing from about 10 to 30 carbon atoms. The dissolution of copper powder with air in the presence of MEA is described. U.S. Pat. No. 4,324,578 discloses a process to prepare an algaecide using copper carbonate, MEA, and triethanolamine.

The prior art processes using copper metal had kinetics which were very poor such that the process was unattractive from a commercial standpoint. The kinetics of the processes are improved if the amine is initially carbonated, but dissolution of 100 grams of copper into a liter of an alkanolamine/water mixture typically took 3 to 6 days.

A need exists for additional efficient, fast, and inexpensive processes for producing copper containing aqueous solutions, suitable for use in the wood-treatment industry. The present invention seeks to fill that need.

### SUMMARY OF THE INVENTION

The invention relates to dissolving copper metal in aqueous monoethanolamine solutions in the presence of oxygen (air, oxygen-enriched air, or oxygen) and carbon dioxide.

Co-owned U.S. Pat. No. 6,646,147, the disclosure of which is incorporated herein by reference and to which this application claims priority, describes a process which accelerated the dissolution rate of copper in a partially carbonated aqueous MEA solution to a rate where copper-MEA-carbonate compositions could be formulated at rates (and costs) that made this process commercially feasible for the wood preservative market. The kinetics of the processes are further improved if the partially carbonated aqueous MEA solution comprises a small amount of dissolved copper, and dissolution of 100 grams of copper into a liter of a partially carbonated aqueous MEA solution can be achieved in under 6 hours. This patent has claims to dissolving a copper mass with an oxidant and aqueous leach liquor containing MEA and (HMEA)₂CO₃, wherein said leach liquor is produced by partially carbonating the MEA. This patent also has claims to the above process at a temperature between 45° C. and 65° C., and to this process where the average Cu dissolution rate is at least 17 g Cu/L/hr.

Co-owned U.S. Pat. No. 6,905,531, the disclosure of which is incorporated herein by reference and to which this application claims priority, also describes a process which accelerated the dissolution rate of copper in a partially carbonated aqueous MEA solution to a rate where copper-MEA-carbonate compositions could be formulated at rates (and costs) that made this process commercially feasible for the wood preservative market. This patent has claims to dissolving a copper mass with an oxidant and aqueous leach liquor containing MEA and (HMEA)₂CO₃, wherein said leach liquor is produced by partially carbonating the MEA, to form a liquid product comprising between 100 and 130 g Cu/L in 12 hours or less. This patent also has claims to dissolving a copper mass with an oxidant and aqueous leach liquor containing MEA and (HMEA)₂CO₃, wherein said leach liquor is produced by partially carbonating the MEA, to form a liquid product comprising between 100 and 130 g Cu/L, where the process is a continuous process and dissolves between 3.65 and 9.27 g Cu/L/hr. This patent also has claims to dissolving a copper mass with an oxidant and aqueous leach liquor containing MEA and (HMEA)₂CO₃, (where the H associated with the MEA is obtained from carbonic acid) wherein said leach liquor is produced by partially carbonating the MEA, comprising providing to the reactor a copper mass, wherein the weight of the copper mass provided to the batch reactor is between ⅔ and 1 grams per ml of aqueous leach liquor provided to the reactor; providing to the reactor air, oxygen, or mixture thereof and contacting the leach liquor with the air, oxygen, or mixture thereof and with the copper mass, thereby causing dissolution of a portion of the copper mass and forming the copper-containing aqueous solution product, wherein the temperature of the leach liquor is maintained at a temperature between 40° C. and 80° C., wherein the amount of dissolved copper in the copper-containing aqueous solution product is between 100 grains per liter and 130 grams per liter in 12 hours or less.

Co-owned U.S. Pat. No. 6,905,532, the disclosure of which is incorporated herein by reference, also describes a process which accelerated the dissolution rate of copper in a partially carbonated aqueous MEA solution to a rate where copper-MEA-carbonate compositions could be formulated at rates (and costs) that made this process commercially feasible for the wood preservative market. This patent has claims to dissolving a copper mass with an oxidant and aqueous leach liquor containing MEA and (HMEA)₂CO₃, wherein said leach liquor is produced by partially carbonating the MEA, while maintaining the pH of the aqueous leach liquor between 8 and 13, wherein said aqueous leach liquor is produced by partially carbonating the monoethanolamine, the aqueous leach liquor comprises about 30% and about 45% by weight of total monoethanolamine, and wherein the aqueous leach liquor dissolves between 100 grams and 130 grams of copper per liter of aqueous leach liquor in 48 hours or less. This patent also has claims to a process for producing a copper-containing aqueous solution product, said process comprising: providing in a packed tower a copper mass having a three dimensional open network permeable to an aqueous solution; providing an aqueous leach liquor comprising water, monoethanolamine, and (HMEA)₂CO₃, wherein said aqueous leach liquor is produced by forming an aqueous composition comprising between 0.5% and 30% by weight of carbon dioxide and about 30% and about 45% by weight of monoethanolamine; providing air, oxygen, or mixture thereof; and contacting the aqueous leach liquor with the air, oxygen, or mixture thereof and with the copper mass, thereby causing dissolution of a portion of the copper mass and forming the copper-containing aqueous solution product, wherein the aqueous leach liquor pH is between 8 and 13 and the temperature is between 25° C. and 100° C., and wherein the aqueous leach liquor dissolves between 100 grams and 130 grams of copper per liter of aqueous leach liquor in 48 hours or less.

The present claims are directed to a variation of the process described in U.S. Pat. No. 6,646,147 and in U.S. Pat. No. 6,905,531.

In particular, in one embodiment the present invention comprises dissolving a copper mass with an oxidant, particularly air, and aqueous leach liquor containing MEA and (HMEA)₂CO₃, wherein said leach liquor is produced by partially carbonating the MEA and further contains at least 1.9 g/L of dissolved copper in initial aqueous leach liquor. Advantageously the initial charge of the aqueous leach liquor contains 1.9 or 13.7 g/L of dissolved copper. Advantageously the ratio of copper mass surface area to volume of leach liquor is about 10-20:1 (length units).

In another embodiment the present invention comprises dissolving a copper mass with an oxidant and aqueous leach liquor containing MEA and (HMEA)₂CO₃, wherein said leach liquor is produced by partially carbonating the MEA and further contains between 1.9 g/L and 13.7 g/L of dissolved copper in initial aqueous leach liquor, to form a liquid product comprising between 100 and 130 g Cu/L in 48 hours or less, for example in 24 hours or less. Advantageously the temperature is controlled between 400 C. and 80° C., more particularly between 45° C. and 65° C. Advantageously this process is done where the ratio of copper surface area to volume of leach liquor is about 10-20:1 length units. Advantageously the average Cu dissolution rate is average Cu dissolution rate is 5 to 36 g Cu/L/hr, more particularly between 8 to 18 g Cu/L/hr.

A major advantage to the process of the current invention, however, is to provide a product having at least about 100 grams of dissolved copper per liter in 12 hours or less. Such a process requires average dissolution rates of greater than about 8.3 grams of copper per liter of aqueous leach liquor per hour. More preferably, the most preferred embodiments of the invention provide a product having at least about 100 grams of dissolved copper per liter in 8 hours or less. Such a process requires average dissolution rates of greater than about 12.5 grams of copper per liter of aqueous leach liquor per hour. A process that takes six hours or less is most preferred, as a batch can be prepared, processed, and shipped in a normal 9 hour work-day. Such a process requires average dissolution rates of greater than about 16 grams of copper per liter of aqueous leach liquor per hour.

We have found that the copper dissolution rate is slow at the beginning and at the end of the dissolution process, and is faster in the intermediate portion of the process. The key to obtaining a product in 4 to 6 hours is minimizing the slow start-up and the slow finish. If an aqueous leach liquor at room temperature is added to a copper mass also at room temperature, the dissolution rate will be very slow, e.g., in the range of a gram of copper per liter of aqueous leach liquor per hour. Such a slow reaction rate may not generate sufficient heat to sufficiently raise the temperature of the aqueous leach liquor into the preferred ranges, which would assure a faster reaction and generation of sufficient heat to achieve even higher temperatures. Therefore, the aqueous leach liquor and copper must usually be heated at the beginning of a batch process, and then heat must be withdrawn from the system as copper dissolution proceeds. The simple process of adding acid (e.g. carbon dioxide which when dissolved forms carbonic acid) to alkanolamine generates some heat. The initial heating can be at least partially accomplished by admixing a portion of the acid, for example between one tenth to all of the total moles of acid to be added, typically from three tenths to eight tenths of the total moles of acid to be added, with the aqueous alkanolamine composition to form the aqueous leach liquor. The heat resulting from the initial addition of acid to aqueous alkanolamine advantageously is used to pre-heat the resulting aqueous leach liquor and the copper. Typically, additional heat may be added in the early stages of the process to further increase the temperature, for example using a heat exchanger. Advantageously the heat exchanger can also remove heat, and is used to withdraw heat when copper dissolution exceeds a moderate value, e.g., about 5 to 10 grams of copper per liter aqueous leach liquor per hour. Heat will need to be withdrawn to prevent the reaction temperature from exceeding the predetermined level, e.g., 65° C. or 80° C.

Generally, it is also advantageous to add a quantity of dissolved copper to the initial leach liquor. We have surprisingly found that the copper dissolution rates remain low even in pre-heated aqueous leach liquor until the aqueous leach liquor builds up some critical level of copper. Without being bound by theory, the copper(II) ions in the aqueous leach liquor may react with copper metal to create copper(I) ions, which are in turn rapidly oxidized by the air into copper(II) ions. The copper dissolution rate in an aqueous leach liquor is low until the copper concentration reaches some value, and this value is between 1 gram to 17 grams of dissolved copper per liter. In the Examples very high initial copper dissolution rates are observed when the initial leach liquor has 1.9 and 13.7 grams of copper dissolved therein. This critical concentration, which may be for example between 2 to 10 grams of dissolved copper per liter of aqueous leach liquor, can be reached by allowing the pre-heated aqueous leach liquor to react with oxidant and copper for a period of 30 minutes to 4 hours (depending on temperature, flowrates, and other criteria). Alternatively, an initial dissolved copper concentration can be immediately established in the fresh aqueous leach liquor if some residual product, e.g., 2% to 6%, from a previous batch run is left in the reactor.

Alternatively or additionally, a fast startup can be achieved if the amount of oxygen in the air sparged through the reactor is increased, to say at least 25%, or to at least 30%.

There may be more than one dissolution reactor. Heating the composition from ambient to at least about 40° C. using fuel can be very expensive. In an alternative embodiment, a small heated dissolution reactor can be used to preheat some aqueous leach liquor, and beneficially will this heated leach liquor will dissolve some copper contained therein and become even hotter, to say a temperature between about 55° C. and 80° C. This partially used and heated leach liquor can be added to an existing reactor containing additional leach liquor and copper mass, and the process of this invention can proceed. The amount of leach liquor from the heated reactor is generally less than 20% of the total leach liquor, say between 3% and 10% of the total leach liquor. The heated leach liquor from the small reactor will provide heat to the larger body of leach liquor and copper mass in the regular reactor, and will also provide an initial low concentration of dissolved copper in the leach liquor, both of which will make the process in the larger reactor react faster.

At the beginning of the process heat must be added to the leach liquor and/or to the copper mass, and subsequently heat must be withdrawn from the leach liquor and/or copper mass. The process can be carried out in each of two reactors, using appropriate heat exchangers to transfer heat from a process in a first reactor that is dissolving copper at a rapid rate, e.g., greater than 10 grams copper per liter per hour, to the leach liquor and copper mass in a second reactor which is at startup and needs input of heat.

The desired end product comprises 90 g/l to 140 g/l, and preferably 100 g/l to 130 g/l of dissolved copper in the copper-containing solution product. According to the preferred embodiments of the process, a MEA-based copper-containing solution comprising between 100 and 130 grams per liter of dissolved copper per liter may be produced in 48 hours or less, more usually within about 24 hours or less, for example in 12 hours or less, from an initial aqueous leach liquor that comprised less than about 13.7 grams, for example about 10 grams or less, of dissolved copper per liter.

Alternatively, a product containing between about 100 and 130 grams of dissolved copper is made in two steps, wherein the first step occurs in a reactor having greater amounts of air flow and is terminated after the copper concentration exceeds, for example, 90 grams, or 100 grams, or 110 grams per liter. Then, the rates of addition of oxidant can be reduced, for example by 50%, and the aqueous leach liquor can continue to dissolve copper at the slower rate. The mixing (providing turbulent flow of leach liquor against the copper mass) and temperature maintenance can also be reduced during this second stage. To maximize plant facilities, it may be desirable to transfer the aqueous leach liquor to a second reactor providing a less vigorous oxidant addition, where the slower dissolution can occur in a less energy-consuming process using a simpler reactor design that is less expensive to operate.

In a variant of this two-step process, the fast dissolution process can be followed by a period of time where the reaction rate is greatly reduced, which has the side benefit of allowing the reactor to cool, e.g., overnight. To conserve energy and to lower the reaction rates, the amount of oxygen being sparged through the reactor can be reduced, to say between about 0.01 to about 0.2 SCF air per gallon of leach liquor. The reduced rate of sparging will conserve energy, and also lack of oxygen will further slow the reaction and allow the leach liquor to cool. The circulation rate can be reduced, and/or heat can be withdrawn at a rate faster than it is withdrawn during the intermediate portions of the process. Therefore, while the reaction proceeded to give a product in less than 48 hours, simply circulating the reactants while allowing the reactor, the copper mass, and the leach liquor to cool, can extend the process and more efficiently load the leach liquor with dissolved copper with little downtime that would not be experienced simply to cool the reactor, replenish the copper mass, and prepare for the next batch.

The most effective reactor design is a packed tower. In such a tower, copper mass fills a tower for a substantial height, usually more than 50% of the height, and optionally more than 75% of the height. The copper is advantageously active, which means the surface is clean and is substantially free of oxides and such which may impair copper dissolution. Copper mass can be activated by a simple wash with an acid. As previously described, this acid wash can advantageously form part of the leach liquor. The copper mass may be distributed on plates (not shown) disposed within the tower, or the copper mass may be simply piled up to fill the tower. It is not practicable to stir the leach liquor with this solids loading, so generally the leach liquor is circulated in the reactor. Circulation is preferably vertical, either in an upward direction or in a downward direction. While countercurrent flow can most effectively remove gases from a liquid, it is not critical to utilize all the oxygen in the oxidant gas.

Generally, the reactor should have an opening allowing easy access so that copper mass can be added thereto. The copper mass can be pre-treated to make the surface more active.

### BRIEF DESCRIPTION OF THE DRAWINGS

The present invention will now be described in more detail with reference to the accompanying drawings, in which;

FIG. 1 is a schematic depiction of a batch dissolver to be used for performing the present invention in a batch-wise manner;

FIG. 2 is a plot showing the copper dissolution in the batch process;

FIG. 3 is a plot showing the copper dissolution rate as a function of time;

FIG. 4 is a schematic for continuous production of MEA complex of copper solution;

FIG. 5 is a plot showing the copper dissolution rate versus air flow rate in a continuous process at pH 9.6;

FIG. 6 is a plot showing the copper dissolution rate versus air flow rate in a continuous process at pH 9.5;

FIG. 7 is a plot showing the copper dissolution rate as a function of pH; and

FIG. 8 is a plot showing the copper dissolution in the batch process at relatively low (2% by weight) initial carbon dioxide concentration.

### DETAILS OF PREFERRED EMBODIMENTS

According to the process, the copper mass is dissolved in the presence of an oxidant in an aqueous leach liquor containing monoethanolamine and (HMEA)₂CO₃. Typically, for a 1 liter chamber, the air flow ranges from about 2-20 SCFH, for example 3-10 SCFH. The air flow SCFH will increase as the volume of the chamber increases.

The leach liquor is produced by partially carbonating the monoethanolamine and may be generated externally of the dissolver or in situ in the chamber through addition of carbon dioxide to the monoethanolamine/water solution by sparging or bubbling into the chamber. Usually, the leach liquor is produced externally of the chamber and introduced into the chamber into contact with the copper as required, or recirculated as necessary.

The dissolution process can take place at any pressure, e.g., from about 12 psia to about 150 psia. While operation under pressure will increase the oxidation rate, it is generally preferable to operate the dissolution process at near atmospheric pressure to keep the cost of the reactor to a minimum. Generally, it is preferred that the oxidant be added to a packed column having copper mass and an aqueous alkanolamine composition, such that the oxidant bubbles or sparges upward through the composition contacting the copper mass. The oxidant, e.g., air, will therefore necessarily be added at greater than atmospheric pressure even if the reactor is vented to the atmosphere, to over-come the hydrostatic pressure of the leach liquor above the oxidant (air) inlets. The reactor can also have some positive pressure to allow treatment of exiting gas. Therefore, the oxidant may be added at a positive pressure, e.g., between about 0.1 to about 20 psig, for example from about 0.3 to about 10 psig.

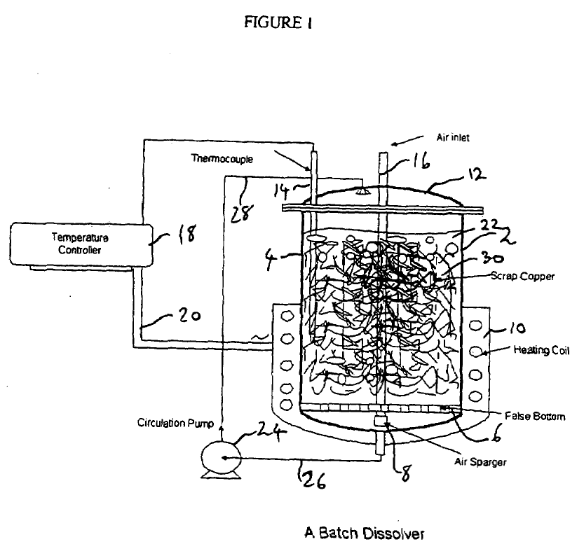

Referring to FIG. 1, there is shown a batch reactor (also called a dissolver), generally referenced 2, having a chamber 4, with a false bottom 6, and an air sparger 8 located below the false bottom. The chamber is surrounded by a heating coil 10 and has a top 12 through which extend a thermocouple 14 and an air inlet 16. The thermocouple is connected to a temperature control unit 18 and supplies heat to the heating coil 10 through conduit 20. Leach liquor 22 is circulated through the chamber by circulation pump 24 through lines 26,28. In the embodiment shown, the aqueous leach liquor flows in an upward direction. Copper metal 30, typically scrap copper, is present in the chamber and immersed in the leach liquor to enable the dissolution to occur.

The term “copper” as used herein means copper metal, including scrap copper, such as, for example, copper wire, copper clippings, copper tubing, copper cabling and/or copper plate, compounds of copper, such as copper oxide, and/or mixtures of copper metal and copper compounds. The term “copper mass” as used herein refers to copper metal in a form which, when present in the chamber, is permeable to the leach liquor and which presents high surface area for contact with the leach liquor to thereby expedite dissolution of the copper. A bale may have a volume of for example about 25-100 cubic feet. Advantageously, there is at least 4 square feet, preferably at least 10 square feet, of available surface area per bulk cubic foot of copper mass (or per cubic foot of the bale). The copper mass may be present for example as a three-dimensional open permeable network, such as a bale of scrap copper comprised of copper wire, copper tubing, copper cabling, copper plates, providing voids between the copper pieces to allow free flow and maximum contact of the leach liquor with the copper. The copper mass may be present in the chamber as smaller irregular shaped pieces resembling “popcorn” (“blister shot”) having an average dimension of about 1-3″, which allow for good permeation of the leach liquor between and around the copper pieces to expedite dissolution thereof. The copper mass advantageously includes one or more of copper saddles, bent coins, popcorn, irregularly shaped spheres, spheres, wire, tubing, blister shot, bent rods, and the like. The key is to provide an open network of copper with a high surface area, so the aqueous leach liquor can permeate the copper mass and the dissolution rate can be maximized. Closely packed regularly shaped copper may be too impermeable to support rapid dissolution.

In one embodiment the ratio of copper surface area to volume of leach liquor is about 10:1 to 20:1 (e.g., in units of cm.sup.2 and cm.sup.3). There is no upper limit on the amount of copper mass, and in one embodiment the ratio of copper surface area to volume of leach liquor (e.g., in units of cm.sup.2 and cm.sup.3) is about 20:1 to 200:1. Typically, the ratio of copper surface area to volume of leach liquor for this process versus a standard agitated reactor is about 10-20:1, for example about 15:1. The amount of copper in the reactor is also advantageously at least 10 to 20 times the amount of copper found in a standard reactor.

Usually, the leach liquor is produced externally of the chamber and introduced into the chamber into contact with the copper as required, and the leach liquor is recirculated as necessary. If the counter-ion(s) comprise carbonate, the leach liquor is produced by partially carbonating the MEA by sparging or bubbling carbon dioxide through the aqueous MEA, and the leach liquor may be generated externally of the reactor or in situ in the reactor through the addition of carbon dioxide to the aqueous MEA-based leach liquor. To maximize the dissolution of copper, it is important that the aqueous leach liquor move past the copper and is most beneficial if a turbulent manner is used to reduce the effects of diffusion on the dissolution process. Stirring is impractical with such a large loading of copper. The turbulence can be provided by the air sparging, but beneficially the aqueous leach liquor is also flowing past the copper surfaces. Such flow can be obtained by a circulating pump, which circulates the aqueous leach liquor, for example by withdrawing a portion of the leach liquor from the bottom of the reactor and re-introducing the aqueous leach liquor at the top of the reactor. The composition of the leach liquor can be monitored and adjusted during the circulation. The leach liquor may be supplemented during the dissolution process with one or more components as necessary to maintain the desired copper dissolution rates. The supplements most commonly needed are acids comprising the counter-ions, if the pH is too high, or additional alkanolamines, e.g., MEA, if the pH is too low. If the leach liquor is being circulated, the leach liquor may be tested and if necessary additional acid (e.g., boric acid, carbon dioxide, or both) can be added to the leach liquor, again either externally of the reactor or in situ in the reactor through addition of carbon dioxide to the MEA/water solution by sparging or bubbling.

The term “partially carbonating” as used herein means that the amount of carbon dioxide introduced during the process is controlled such that partial carbonation occurs to form a known concentration of (HMEA)₂CO₃. Preferably, the carbon dioxide is present in an amount of about 12% or less by weight. The carbon dioxide may be present in an amount of at least 0.5% by weight, for example at least 5% or at least 8% by weight.

The MEA is beneficially present in the aqueous leach liquor in an amount of 20 weight percent or more, for example, 30 weight percent or more, such as 35 weight percent or more. The MEA may be present in the aqueous leach liquor in an amount of 50 weight percent or less, for example 40 weight percent or less, for example, 38 weight percent or less. A preferred leach liquor comprises between 30% and about 45% by weight of the total MEA, e.g., between 34% to 38% by weight MEA. With respect to quantities, the quantity of MEA is the quantity of total MEA, which can exist as MEA, as an HMEA-anion complex, and as a copper-HMEA-MEA-anion complex. The amount (in weight percent) of the acid depends on the molecular weight of the acid anion and on the valence of the anion (counter-ion) donated by the acid. An exemplary carbonate-based aqueous leach solution comprises about 30% to 50% MEA and 1% to 12% carbon dioxide, for example about 34% to 38% MEA and about 6% to 8% by weight carbon dioxide (which forms carbonic acid in water).

The present inventors have discovered that it is not necessary to utilize precursors, such as copper carbonate, copper sulfate, copper borate, or the like which is expensive. The dissolution of the copper metal may be achieved in the presence of water, MEA, (HMEA)₂-(counter-ion), and an oxidant at preferably elevated temperature, without the need for the addition of ammonium compounds, such as ammonium hydroxide, fungicidal anions, polyamines, carboxylic acids, alkali metal hydroxides such as sodium hydroxide, and/or alcohol-based solvents.

The leach solution may be re-circulated in the reactor. Re-circulation benefits the mass transfer and reaction rate. If performed, re-circulation may be implemented at a constant rate, and may be, for example, a constant rate of about 15 percent or less, for example, 10 percent or less of the leach liquor volume per minute. The recirculation may be performed at a rate of about 1 percent or more, such as 2 percent or more of the leach solution volume per minute. Recirculation rates are beneficially between 1/50 and ⅓, for example between about 1/30 and 1/10 of the leach liquor volume per minute. The process may be carried out at atmospheric pressure and at a temperature of 25-100° C., for example 30-90° C., alternatively from 45-65° C. The temperature may be maintained at 45-55° C. The pH may be maintained in a basic region, for example, greater than 7, for example at least 8, or at least 9. The pH may be less than 13, for example, about 12.5 or less. The pH may be maintained by addition of carbon dioxide as acid, and by addition of MEA as base.

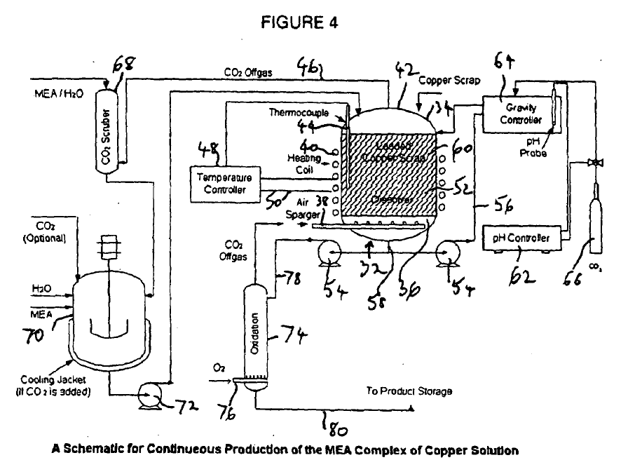

The dissolution may be carried out in a batch dissolver (see FIG. 1), or may be performed as a continuous process in towers packed with copper (see FIG. 4), or the process can be a hybrid of the two. Typically, the copper and MEA/acid/H.sub.2O solution are charged into the dissolver, and the circulation pump, air-flow and temperature controller are actuated. The amount of copper at the beginning of the process is at least 200 grams, preferably at least 400 grams, and typically between 1000 grams and 5000 grams per liter of aqueous leach liquor. The temperature is beneficially between 30° C. and 90° C., for example between 40° C. and 80° C. The aqueous leach liquor may be preheated to start the reaction, where after the dissolution rate exceeds a certain value, heat is beneficially withdrawn from the aqueous leach liquor to maintain the temperature within the desired range. The temperature may be held constant or may be allowed to drift within a pre-set range. Examples of conditions are given in Table 3 below.

FIG. 4 is a schematic for the continuous production of MEA complex in solution. The dissolver, generally referenced 32, has a chamber 34, with a false bottom 36, and an air sparger 38 located below the false bottom. The chamber is surrounded by a heating coil 40 and has a top 42 through which extend a thermocouple 44 and an outlet 46. The thermocouple is connected to a temperature control unit 48 and supplies heat to the heating coil 40 through conduit 50. Leach liquor 52 is circulated through the chamber by circulation pumps 54 through lines 56,58. A copper mass 60 is present in the chamber and immersed in the leach liquor to enable the dissolution to occur.

The system is also provided with a pH control 62 connected to a specific gravity controller 64 into which carbon dioxide is admitted from tank 66. Carbon dioxide off-gas is directed through line 46 to a carbon dioxide scrubber 68. Carbon dioxide from the scrubber 68 is the fed to chamber 70 containing MEA and water which is pumped via pump 72 to chamber 34. The system also comprises an oxidation chamber 74 into which oxygen is admitted via line 76. Product enters at line 78 and following oxidation exits via line 80 and is transferred to product storage.

### EXAMPLES

Examples of the process according to the present invention will now be described. The invention is intended to be illustrated, but not limited, by the examples.

### Example

### Batch Dissolution

Dissolving studies were conducted either batch-wise or continuously, FIG. 1 shows a conventional batch dissolver used for the batch-wise operation. FIG. 4 shows a continuous dissolution process. The conditions used in the batch experiments are given in Table 1. The temperature was maintained at 45-55° C. The solution concentration of copper (g/l) as a function of dissolution time is shown in Table 2.

TABLE 1
Leach Solution

| Exp ID. | Amine, % | CO₂, % | Volume, ml | Cu charge, g % |
|---|---|---|---|---|
| 1 MEA-CO₂ | 36.7 | 12 | 600 | 400 |
| solution | | | | |
| 2 MEA-CO₂ | 35.9 | 12 | 200 | 200 |
| solution | | | | |

TABLE 2
g Cu/l

| | Dissolution Time, hours | | | | | | | |
|---|---|---|---|---|---|---|---|---|
| | 1 | 2 | 3 | 4 | 5 | 6 | 7 | 8 |
| EXP #1 | 3.7 | 15.7 | 41.3 | 67.8 | 88.2 | 100.3 | | |
| EXP #2 | 5.4 | 16.8 | 67.8 | 85.1 | 102.6 | 119.2 | 126.4 | 136.1 |

In experiments 1 and 2, reported above, average copper dissolution rates of about 17 g/1-hr were achieved over the course of the experiments. At those rates, the process is viable commercially. Raw material costs, processing costs and waste are significantly reduced over the conventional process using copper carbonate.

### Example

### Batch Preparation of Mea Complex of Copper Carbonate

MEA complex of copper carbonate solutions were prepared by dissolving a copper metal mass in monothanolamine/CO₂/H₂O solution in the batch dissolver in the presence of air sparging and at an elevated temperature. FIG. 1 shows a conventional batch dissolver used for the batch-wise operation. Three experiments were conducted using the batch dissolver shown in FIG. 1. In each experiment, about 1200 g copper and 1 liter MEA-CO₂—H₂O solution were charged into the dissolver. The circulation pump, airflow and temperature controller were then started. The experimental conditions are given in Table 3. Diisolution data is given in Tables 4, 5, and 6.

TABLE 3

| | MEA-H₂O—CO₂ Solution | | | Air | | Circulation |
|---|---|---|---|---|---|---|
| Exp | MEA/H₂O | | | Flow | Temp. | Rate |
| ID | (wt ratio) | CO, % | Sp. G | SCF/H | ° C. | ml/min |
| 1 | 0.900/1.00 | 13.7 | 1.165 | 6.0 | 51. + −.1 | 182 |
| 2 | 0.733/1.00 | 14.1 | 1.160 | 6.0 | 51. + −.1 | 182 |
| 3 | 0.900/1.00 | 13.7 | 1.165 | 6.0 | 76. + −.1 | 182 |

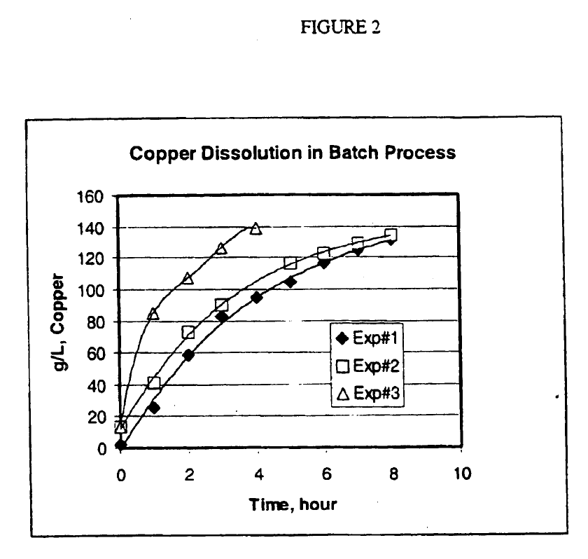

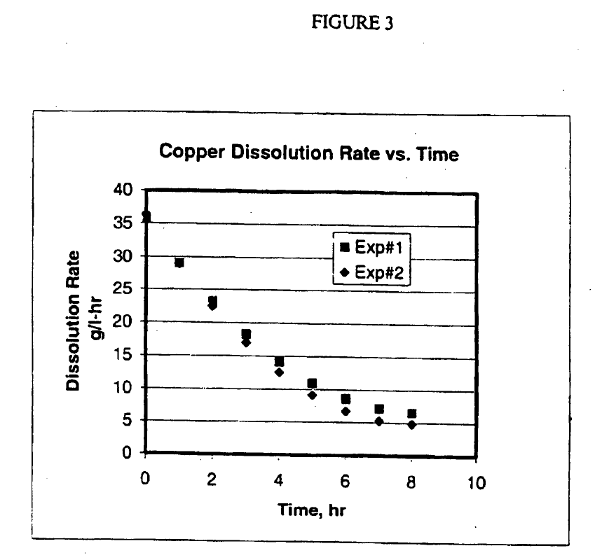

When temperature reached the target temperature, the first sample of each batch was taken for analysis, and the timer was started. Complete results of these three dissolving batches are shown below, and are presented in FIGS. 2 and 3. FIG. 2 is a plot showing the copper dissolution in the batch process, and FIG. 3 is a plot showing the copper dissolution rate as a function of time.

TABLE 4
Batch Dissolving, Experiment #1

| Time, hour | % Cu | pH | Sp. G. | Copper, g/L |
|---|---|---|---|---|
| 0 | 0.16 | 8.8 | 1.165 | 1.9 |
| 1 | 2.155 | 9.6 | 1.175 | 25.3 |
| 2 | 4.85 | N/a | 1.205 | 58.4 |
| 3 | 6.73 | 9.45 | 1.228 | 82.6 |
| 4 | 7.66 | 9.6 | 1.239 | 94.9 |
| 5 | 8.36 | 9.6 | 1.251 | 104.5 |
| 6 | 9.23 | 9.6 | 1.262 | 116.5 |
| 7 | 9.79 | N/a | 1.271 | 124.4 |
| 8 | 10.32 | 9.65 | 1.277 | 131.8 |

TABLE 5
Batch Dissolving, Experiment #2

| Time, hour | % Cu | pH | Sp. G. | Copper, g/L |
|---|---|---|---|---|
| 0 | 1.17 | 9.00 | 1.170 | 13.7 |
| 1 | 3.5 | 9.25 | 1.180 | 41.3 |
| 2 | 6.07 | 9.30 | 1.204 | 73.1 |
| 3 | 7.37 | 9.37 | 1.223 | 90.1 |
| 4 | | | | |
| 5 | 9.29 | 9.55 | 1.250 | 116.1 |
| 6 | 9.76 | 9.65 | 1.258 | 122.7 |
| 7 | 10.23 | 9.65 | 1.265 | 129.4 |
| 8 | 10.63 | 9.65 | 1.267 | 134.7 |

TABLE 6
Batch Dissolving, Experiment #3

| Time, hour | % Cu | pH | Sp. G. | Copper, g/L |
|---|---|---|---|---|
| 0 | 1.175 | 9.45 | 1.175 | 13.8 |
| 1 | 7.054 | 9.80 | 1.208 | 85.2 |
| 2 | 8.661 | 10.0 | 1.237 | 107.1 |
| 3 | 10.11 | 10.2 | 1.251 | 126.4 |
| 4 | 10.99 | 10.3 | 1.267 | 139.2 |

### Example

### Continuous Process

A continuous dissolver assembly (see FIG. 4) was used in the experiments described below. The assembly includes a one-liter size packed-tower dissolver (used in the batch dissolving experiments described above), a gravity controller, a temperature controller, a pH monitor, an air flow meter, a circulation pump and a pump for simultaneous withdrawal and replenishment of solutions. The gravity controller held about 1 liter of the product solution. The solution in the assembly was circulated between the specific gravity controller and the dissolver at a constant rate of 325 ml per min. Occasionally, carbon dioxide gas was bubbled through the bottom of the gravity control chamber to adjust the pH of the solution. In all experiments described below, the reaction temperature and specific gravity were controlled at 50.+−0.2° C. and 1.271.+−.0.001, respectively. During a continuous dissolving experiment, copper is continuously dissolved and results in a gradual increase in the specific gravity of the copper-containing solution. When the gravity reaches a pre-set value, e.g., 1.272, it triggers a pump to withdraw the product solution and replenish MEA-CO₂ solution simultaneously.

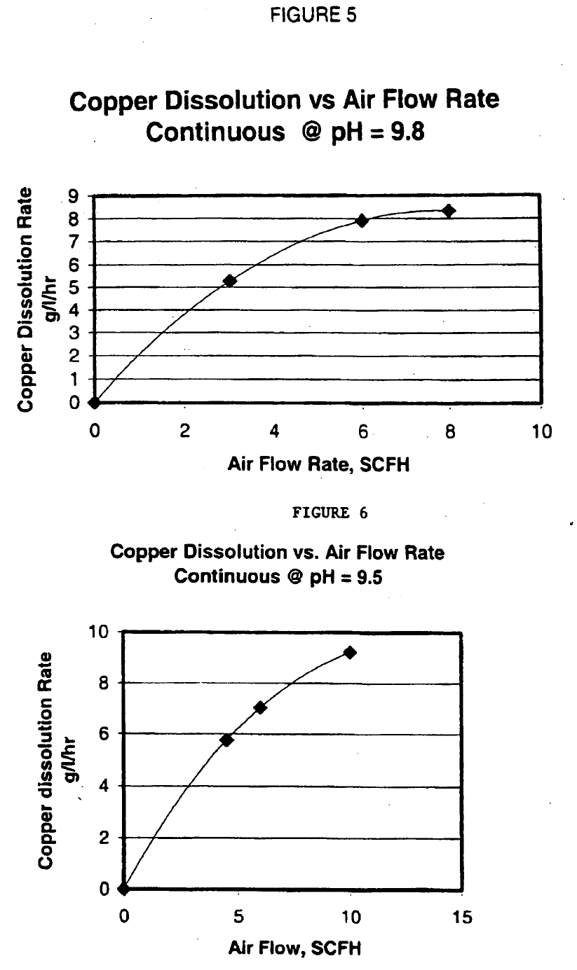

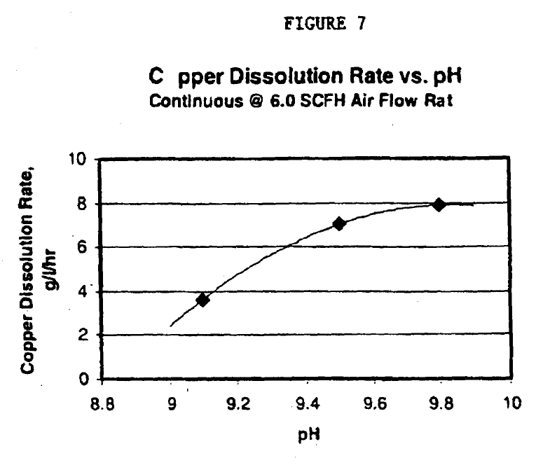

The composition of the MEA-CO₂ solution used in all continuous dissolving experiments is the same as that of Example #3 (Table 3). The dissolver was charged on a daily basis with 1″ pieces of 11-13 AWG scrap copper wires and maintained a total copper loading of 1100-1200 grams at any given period of the experiments. Results are shown below in Table 7 along with the experimental conditions used, and are also presented in FIGS. 5-7: FIG. 5 is a plot showing the copper dissolution rate versus air flow rate in a continuous process at pH 9.8, FIG. 6 is a plot showing the copper dissolution rate versus air flow rate in a continuous process at pH 9.5, and FIG. 7 is a plot showing the copper dissolution rate as a function of pH.

TABLE 7
Conditions and Results of Continuous Dissolving Experiments

| | | Air | | | Copper |
|---|---|---|---|---|---|
| Duration | | Flow | MEA-Cu—CO₃ Solution | | Dissolution |
| Hours | pH | SCFH | Volume, ml | Cu, % | g/l/hr |
| 2.13 | 9.8 | 6.0 | 125 | 10.61 | 7.91 |
| 2.13 | 9.8 | 3.0 | 85 | 10.41 | 5.28 |
| 0.65 | 9.8 | 8.0 | 41 | 10.41 | 8.35 |
| 3.35 | 9.5 | 6.0 | 183 | 10.15 | 7.05 |
| 0.64 | 9.5 | 10.0 | 46 | 10.15 | 9.27 |
| 0.78 | 9.5 | 4.5 | 35 | 10.15 | 5.79 |
| 4.1 | 9.1 | 6.0 | 123 | 9.575 | 3.65 |

### Example

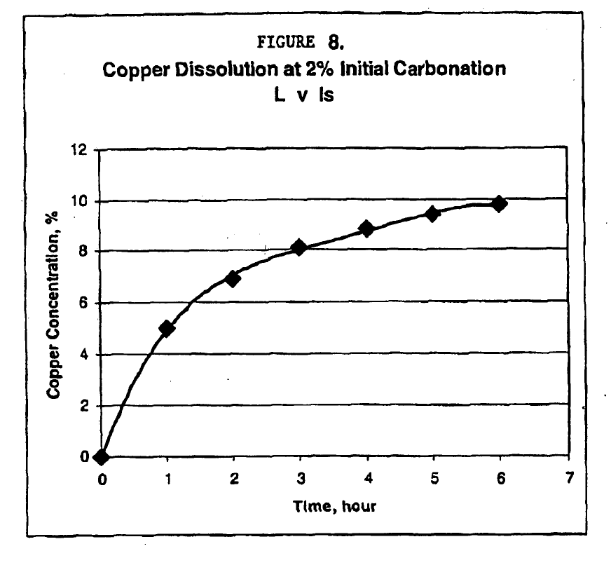

A leach solution using 2% (also one data point for 1% carbonation) carbonation is reported in Table 8 and shown in FIG. 8.

TABLE 8
Summary of Experimental Conditions:
MEA-CO₂ Leach Solution

| EXP. ID | Amine, % | CO₂, % | Volume ml | Cu Charge, g |
|---|---|---|---|---|
| 1 | 39 | 2.0 | 800 | 1250 |
| 2 | 39 | 1.0 | 800 | 1250 |

Copper Concentrations (%) as a Function of Dissolution Time

| Dissolution Time hour | 1 | 2 | 3 | 4 | 5 | 6 |
|---|---|---|---|---|---|---|
| EXP. #1 | 5.0 | 6.9 | 8.1 | 8.8 | 9.4 | 9.8 |
| EXP. #2 | 4.9 | | | | | |

### Example

### Production Scale Batch Preparation of Mea Complex of Copper Carbonate

Commercial quantities of MEA complex of copper carbonate solutions have been prepared by dissolving a copper metal mass in monoethanoiamine/CO₂/H₂O solution in an 11,500 gal vessel in the presence of air sparging at an elevated temperature. FIG. 1, the laboratory scale equipment, also conceptually represents the production scale vessel with only two notable exceptions. Whereas the laboratory scale vessel is glass, the production scale vessel is constructed of a suitable, corrosion resistant material. The selection of materials, e.g., 304 stainless steel, is within the ability of one of ordinary skill in the art. Whereas the laboratory vessel is depicted with a heating mantle, there is a heat exchanger in the recirculation loop in the production equipment that has both heating and cooling capability. Normally, only cooling is required as the simultaneous absorption of CO₂ and dissolution of copper metal are both exothermic events.

While the leachate solution can be prepared in situ or external to the dissolving vessel, it has normally been prepared in situ. In the preparation of the leachate, the initial amount of CO₂ has been varied to demonstrate the threshold value from which a sustained reaction can be initiated. The quantity of air introduced below the perforated false bottom has been varied to demonstrate the overall and peak dissolution rates. Peak dissolution rates and overall dissolution rates are obviously dependent upon the reaction temperature, the initial and final wt % CO₂. It should be noted that the conditions examined herein are constrained only by a combination of an upper temperature, the area of the heat exchanger, and the temperature and flow rate of the cooling tower water for the existing facility. Obviously, faster conversion rates could be attained given additional heat removal capacity so as to maintain the desired temperature. The rate of recirculation through the heat exchanger has been constant at 1/30.sup.th of the active volume of the vessel. The pH range is somewhat pre-determined by the amount of MEA present, the amount of initial CO₂ present, the final amount of CO₂ added, the degree of conversion from copper metal to complexed copper and the quantity of water. The specific gravity has remained relatively constant.

Numerous batches have been produced reflecting a range of operating parameters:

| Parameter | Minimum | Maximum |
|---|---|---|
| Batch Size in liters | 20,500 | 28,400 |
| Initial CO₂ in wt % in leachate | 2.1% | 18.0% |
| Aeration Rate in SF/Sq Ft of X-sectional | 2.25 | 5.10 |
| area | | |
| Temperature range in ° C. | 18 | 68 |
| Initial pH range | 10.2 | 12.7 |
| Range of average dissolution rates in g/l-h | 8.3 | 17.9 |
| Specific Gravity | 1.250 | 1.268 |

Data regarding specific examples are given below: Numerous batches have been produced reflecting a range of operating parameters:

| | Volume, | Initial | Aera- | | | | |
|---|---|---|---|---|---|---|---|
| Batch | L | CO₂ | tion | pH range | Sp Gr | Ave. Diss. Rate | |
| a | 20,500 | 8.0% | 5.10 | 12.7-10.2 | 1.268 | 8.3 | g/l-h/r |
| b | 20,500 | 18.0% | 5.10 | 11.2-10.2 | 1.260 | 15.6 | g/l-h/ |
| c | 20,500 | 4.2% | 5.10 | 11.9, const | 1.26 | 16.3 | g/l-h/ |
| d | 20,500 | 4.2% | 2.25 | 11.9, const | 1.250 | 14.3 | g/l-h/ |
| e | 20,500 | 2.1% | 2.25 | 12.2-11.7 | 1.251 | 17.9 | g/l-h/ |
| f | 28,400 | 2.1% | 2.25 | 12.1-11.0 | 1.256 | 11.2 | g/l-h/ |

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of dissolving a copper mass, comprising contacting a copper mass with an oxidant and an aqueous leach liquor containing monoethanolamine (“MEA”) and (HMEA)₂CO₃, wherein said leach liquor is produced by partially carbonating the MEA, and said leach liquor further contains at least 1.9 g/L of dissolved copper.

2. The method of claim 1, wherein said leach liquor contains 1.9 g/L of dissolved copper.

3. The method of claim 1, wherein said leach liquor contains 13.7 g/L of dissolved copper.

4. The method of claim 1, wherein said leach liquor contains between 1.9 and 13.7 g/L of dissolved copper.

5. The method of claim 1, wherein the copper mass has a surface area, and wherein the ratio of copper mass surface area to volume of leach liquor is about 10-20:1.

6. The method of claim 1, wherein the oxidant is air.

7. A method of dissolving a copper mass, comprising contacting a copper mass with an oxidant and an aqueous leach liquor containing monoethanolamine (“MEA”) and (HMEA)₂CO₃, wherein said leach liquor is produced by partially carbonating the MEA and further contains between 1.9 g/L and 13.7 g/L of dissolved copper, thereby forming a liquid product comprising between 100 and 130 g Cu/L in 48 hours or less.

8. The method of claim 7, wherein a liquid product comprising between 100 and 130 g Cu/L in is formed in 24 or less.

9. The method of claim 7, wherein the temperature is controlled between 40° C. and 80° C.

10. The method of claim 7, wherein the temperature is controlled between 45° C. and 65° C.

11. The method of claim 7, wherein the ratio of copper surface area to volume of leach liquor is about 10-20:1 length units.

12. The method of claim 7, wherein the Cu dissolution rate is 5 to 36 g Cu/L/hr.

13. The method of claim 7, wherein the Cu dissolution rate is 8 to 18 g Cu/L/hr.
